(19) United States
(12) Patent Application Publication
(10) Pub. No.: US 2012/0043876 A1
(43) Pub. Date: Feb. 23, 2012

(54) Two Confronting Planar LED Lamps with Shades

(76) Inventors: Hao-Jan LIN, TAIPEI (TW); Zhan-Qiang ZHANG, WEINAN (CN)

(21) Appl. No.: 12/860,873

(22) Filed: Aug. 21, 2010

(51) Int. Cl. H01J 61/52

(52) U.S. Cl. 313/46

(57) ABSTRACT

An LED lamp is disclosed. The LED lamp includes a concave specular reflector having a top LED plate, a bottom LED plate positioned at both ends of the specular reflector. The top LED plate and the bottom LED plate with the light-emitting area are positioned opposite to each other. Two LED plates are disposed on the circuit boards and positioned back by the heat sinks and thermal releasing caps. A power connector is extended from the two circuit boards and disposed at one end of LED plate to the power cord.

### BACKGROUND OF THE INVENTION

1. Field of the Invention

This invention relates to a structure of an LED lamp, and more particularly to a structure of two confronting planar LED lamp with shades comprising a planar LED lighting structure which serves as a lighting source to provide a radiated illumination under the lampshade without forming a shadow area on a shade.

2. Description of the Related Art

With the environment-protection and energy-saving requirements, LEDs has the advantages of low power consumption, long life and non-pollution, and has become the much needed light source. In order to meet the various applications of the market, planar LED board lighting lamps have been developed to achieve significant progress, such as minimizing the number of chips, increasing brightness, and better cooling housing. To disguise the intense electric light from an incandescent light bulb, lampshades have been used since 19th Century. The employment of the planar LED board on the traditional lamp thereof forms a shadow area on the shades diffused by polarity of the beam pattern. This drawback result in reducing an esthetic and decorative feature and thereby reduce the market value of the LED lighting.

### SUMMARY OF THE INVENTION

The object of the invention is to provide an LED lamp comprising a planar LED lighting structure that resolves the problem of the polarity of the planar LED ray that emits light shadow diffused on the lampshades.

### BRIEF DESCRIPTION OF THE DRAWINGS

The accomplishment of this and other objects of the invention will become apparent from the following descriptions and its accompanying figures of which:

FIG. 1 is a view of a conventional lamp with a single planar LED board with the shade;

FIG. 2A is a view of a planar LED lighting structure according to an embodiment of the present invention;

FIG. 2B is an exploded view of the planar LED lighting structure according to an embodiment of the present invention; and

FIG. 3 is a view of an LED lamp including the planar LED structure with a shade according to an embodiment of the present invention.

### DETAILED DESCRIPTION OF THE PREFERRED EMBODIMENT

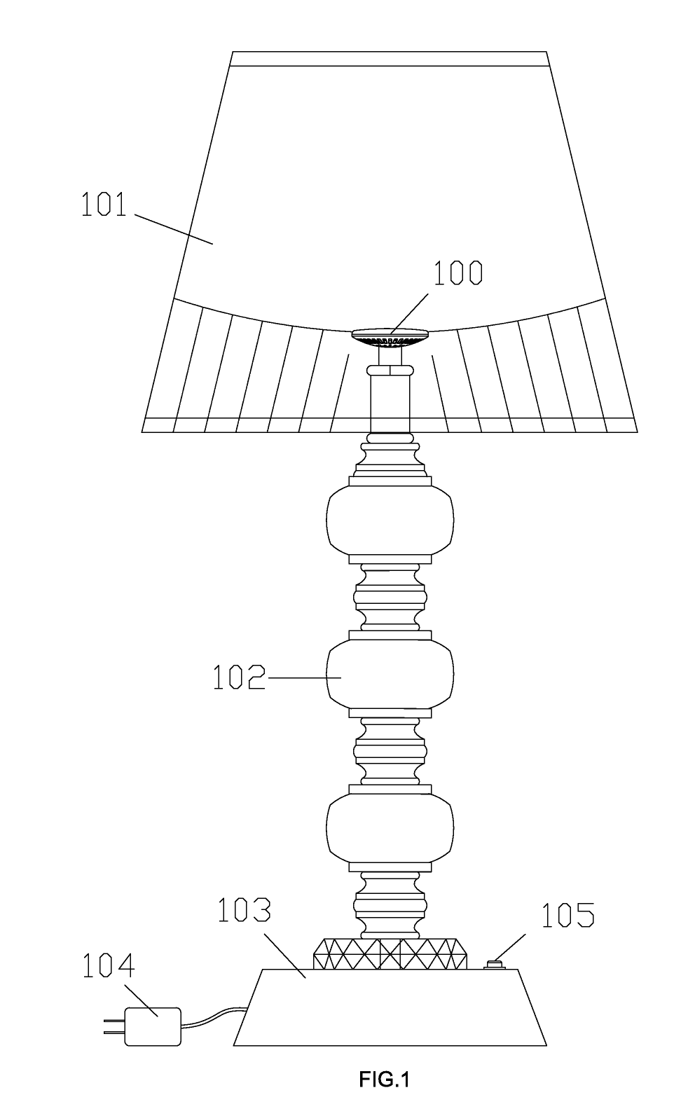

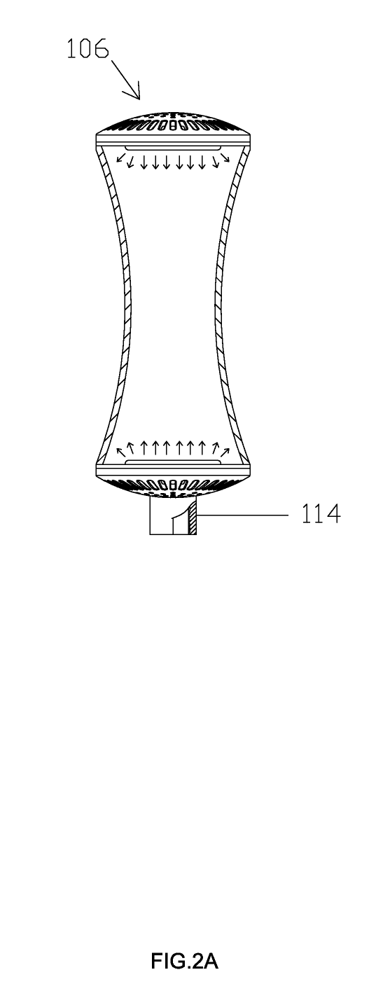

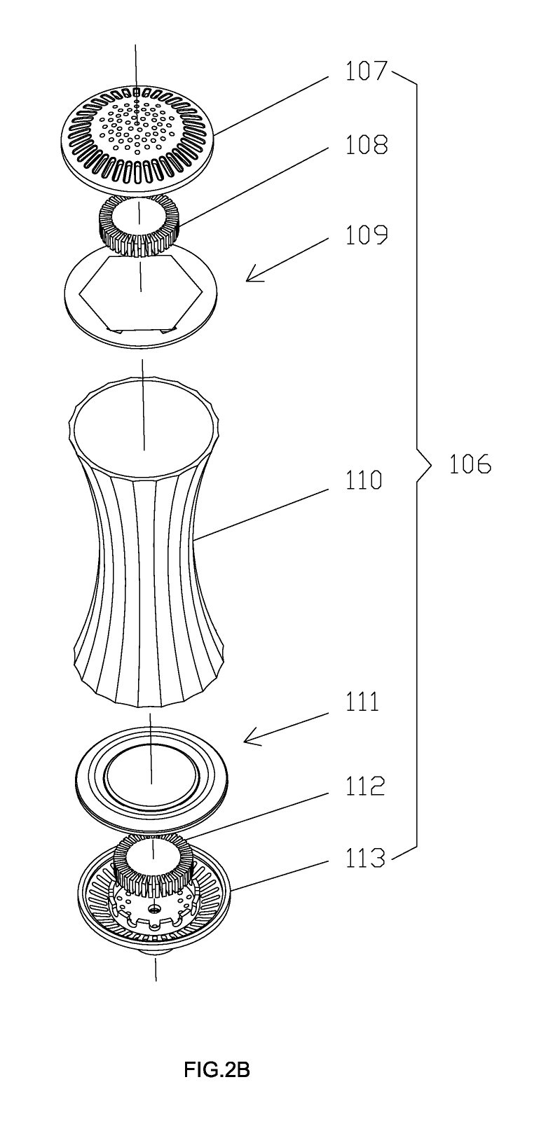

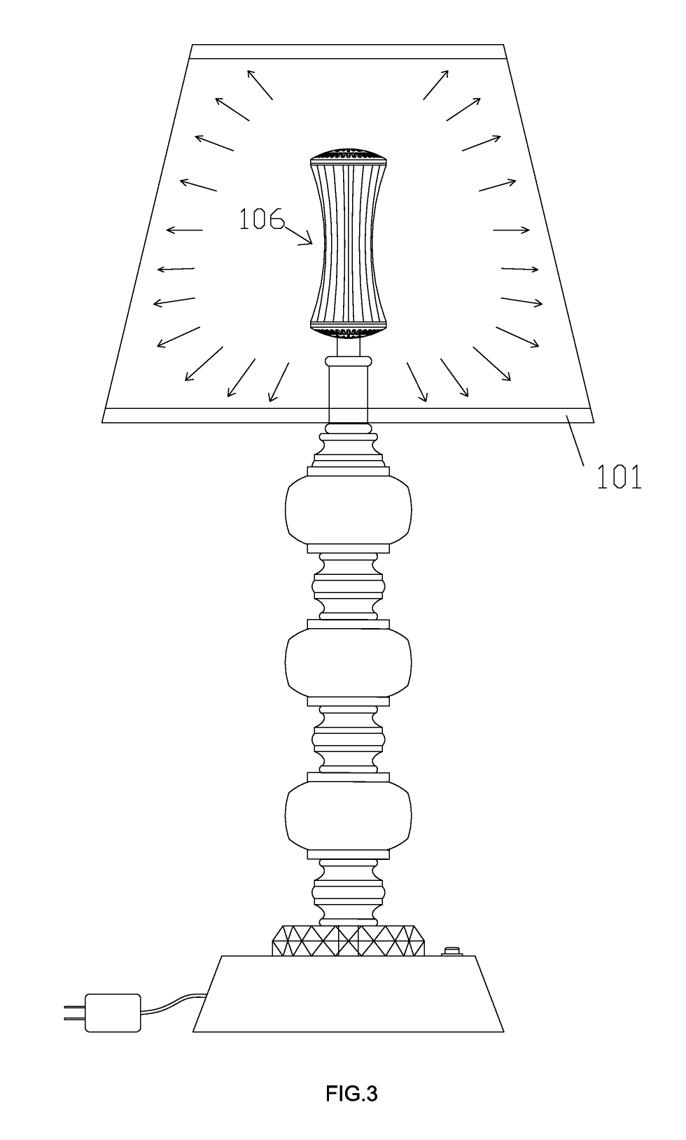

FIG. 1 is a view of a conventional single LED lamp with a shade. FIG. 2 is a view of an embodiment of the present invention comprising two confronting LED boards lighting structure. FIG. 3 is a view of assembly of two confronting planar LED boards with the lampshade. As illustrated in FIG. 1, the conventional single LED lamp 100 comprises a single lighting source, a lamp shade 101, a lamp body 102, a lamp base a transformer plug 104 and a switch 5. The single lighting source 101 is used as a lighting source. A lamp shade 101 is framed to disguise the emission lighting. The lamp body 102 is used to accent the lighting source to a desired height. A lamp base 103 is used to stabilize the lamp body from tilting. An outlet of the transformer plug 104 is used to connect the electricity power. The switch 105 control the lighting in two (on/off) or three (on/off/dimmer) ways. Due to the LED beam pattern, a shadow area, as illustrated by the broken lines in FIG. 1, is formed behind of the planar LED board.

FIG. 2A illustrates a planar LED lighting structure according to an embodiment of the present invention. The planar LED lighting structure 106 is mounted onto a top of the lamp body by a screw tubing 114 and positioned under the lamp shade, wherein the planar LED lighting structure 106 comprises two light-emitting areas illustrated by arrows are positioned opposite to each other.

FIG. 2B illustrates an exploded view of the planar LED lighting structure 106, which comprises at least a pair of thermal releasing caps 107 and 113, at least a pair of heat sinks 108 and 112, and at least a pair of aluminum-based circuit boards 109 and 111 respectively installed at a top and a bottom of a concave specular reflector 110 made of a glass or a plastic material. A power connector extends from the pair of circuit boards for connecting to a power source.

FIG. 3 illustrates an assembly of an LED lamp of the present invention comprising the planar LED lighting structure 106, which serves as a lighting source to provide a 360 degree radiated illumination as illustrated by arrows under the lampshade 101.

Many changes and modifications in the above-described embodiments of the invention can, of course, be carried out without departing from the scope thereof. Accordingly, to promote the progress in the useful arts, the invention is disclosed and is intended to be limited only by the scope of the appended claims.

1. An LED lamp, comprising:
a planar LED lighting structure comprising at least a pair of thermal releasing caps, at least a pair of heat sinks, and at least a pair of circuit boards respectively installed at a top and a bottom or a concave specular reflector facing each other and generating a direction radiated illumination as a light bulb; and
a power connector being extended from the at least pair of circuit boards for connecting to a power source.

2. An LED lamp according to claim 1, wherein the concave specular reflector is made of a glass or a plastic material.

3. An LED lamp according to claim 1, wherein the circuit board is aluminum-based.
